(19) United States
(12) Patent Application Publication
(10) Pub. No.: US 2005/0105535 A1
(43) Pub. Date: May 19, 2005

(54) Content delivery

(76) Inventors: Janne Aaltonen, Turku (FI); Pekka Talmola, Turku (FI); Rod Walsh, Tampere (FI); Juha-Pekka Luoma, Tampere (FI); Tomi Hakkarainen, Nokia (FI)

Correspondence Address: MORGAN & FINNEGAN, L.L.P., 3 WORLD FINANCIAL CENTER, NEW YORK, NY, 10281-2101, US

(21) Appl. No.: 10/496,525

(22) PCT Filed: Nov. 19, 2002
(86) PCT No.: PCT/IB02/04823

(30) Foreign Application Priority Data
Nov. 19, 2001 (GB) 0127650.0

(51) Int. Cl. H04L 12/56

(52) U.S. Cl. 370/395.52; 370/458; 340/310.06

(57) ABSTRACT

A method of defining Time Division Multiplex access slots in an IP address is disclosed. The method comprises steps including the encoding of a schedule of delivery time slots as a mask in said IP address.

### FIELD OF THE INVENTION

The present invention relates to the content delivery utilising Internet Protocol (IP) networking, particularly, although not exclusively IPv4 and IPv6 wireless networks.

### BACKGROUND OF THE INVENTION

Wireless IP networks, and particularly mobile wireless IP networks typically include a terminal having stringent power requirements. Such a mobile terminal may be required to operate for lengthy periods on an internal source of power. In the case of simplex wireless IP networks exemplified by the Digital Video Broadcast (DVB) terrestrial (DVB-T) and satellite (DVB-S) networks, typically a large part of the energy requirement of a terminal is due to the demands of a receiver necessary to receive transmissions carrying a range of content.

It is the case, however, that a user of the terminal may at an application level, as set out in the well-known Open Source Initiative (OSI) model, make a selection of particular content from the range of content presently received by the terminal. Although such a selection may take place in a unicast environment, that is a one to one transmission, more typically the content is distributed in a one to many transmission, that is a multicast environment. A well-known mechanism for facilitating the delivery of content in a multicast environment is provided by the Session Announcement Protocol (SAP), details of which are set out in RFC2974 published by the Internet Engineering Task Force (IETF repository at http://www.ietf.org) and the Session Description Protocol (SDP), details of which are to be found in RFC2327 published by the Internet Engineering Task Force (IETF repository at http://www.ietf.org). In summary, an Application Programming Interface (API) is provided which facilitates communication between applications over an IP protocol. The API listens at a particular address for information identifying available streams of content, so-called services. The information provided at that address is then provided to an application, a browser for example, which in turn uses the API to access a selected stream by opening a socket at which the selected stream can be heard. Typically, the selection of the desired content is made by a user via the browser, i.e. by clicking on a particular link.

### SUMMARY OF THE INVENTION

According to a first aspect of the present invention, there is provided a method of defining Time Division Multiplex access slots in an IP address, the method comprising encoding a schedule of delivery time slots as a mask in said IP address. Preferably, the method is applied to the delivery of data over a simplex broadcast network such as a broadband digital broadcast network. The method may be carried out entirely within the network head-end, in which case the application of TDMA to the content is carried out entirely within parameters set by the network operator. Otherwise, the content provider may apply at the method to content before delivery to the broadcast network. Of course, a combination of each of the above applications is possible.

According to a further aspect of the invention, there is provided a method of deriving Time Division Multiplex access slots from an IP address, the method comprising identifying a portion of said address encoded with a schedule of delivery time slots and decoding said schedule.

The IP address is preferably delivered in a transport stream broadcast over a simplex broadcast network such as a broadband digital broadcast network to a terminal. The schedule derived from the IP address may then be used in the terminal to control the operation of a receiver and thereby reduce power consumption by switching off or otherwise reducing the power consumption of the receiver.

According to another aspect of the invention, there is provided a method of obtaining Time Division Multiplex access slots of a service in an IP transport stream, the method comprising identifying an IP address of a service in said transport stream and decoding a schedule of delivery time slots for said service previously encoded as a mask on said IP address.

Preferably the format of the mask is selected to take account of a IP protocol used by the service an din particular the address space requirements of that protocol. Clearly, various formats may be used to encode the schedule information, the selection of which will depend on the preferences and requirements of the implementation.

According to a still further aspect of the invention, there is provided a service reception method for a terminal including a selectably operable receiver, the method comprising receiving an IP transport stream including an announcement of services in said stream, selecting a service from said stream, deriving from an IP address of said service scheduled delivery time slots for said service encoded in said IP address and selectably operating said receiver in accordance with said schedule to receive said service at said IP address.

Conveniently, the aforesaid SAP/SDP protocols may be utilised to announce services to the terminal. The terminal may then use the information provided thereby to listen at a socket for a selected service.

### BRIEF DESCRIPTION OF THE DRAWINGS

In order to assist in understanding the invention, a number of embodiments thereof will be described by way of example and with reference to the accompanying drawings, in which:

FIG. 1, is a schematic view of a network topology useful in understanding the present invention;

FIG. 2 is diagram illustrating the delivery of services utilising IP addresses encoded with a schedule of delivery slot information in accordance with the invention;

FIG. 3, is a diagrammatic view of a terminal for reception of a transport stream incorporating the services of FIG. 2; and

FIG. 4 is a schematic view of illustrating the mode of operation of the terminal of FIG. 3 in relation to an OSI transport model.

### DETAILED DESCRIPTION

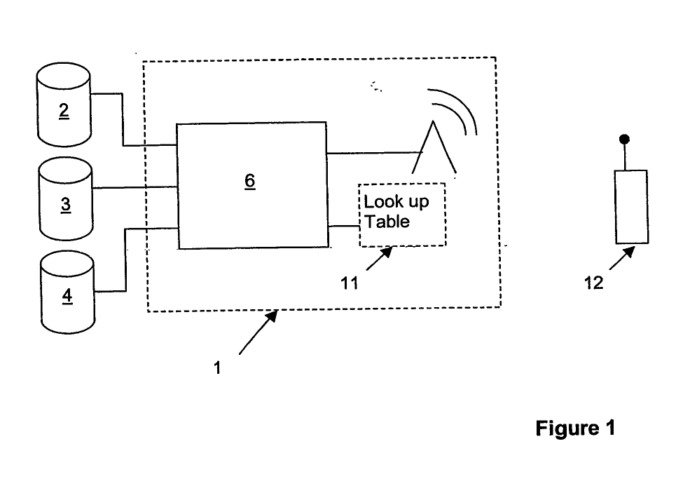

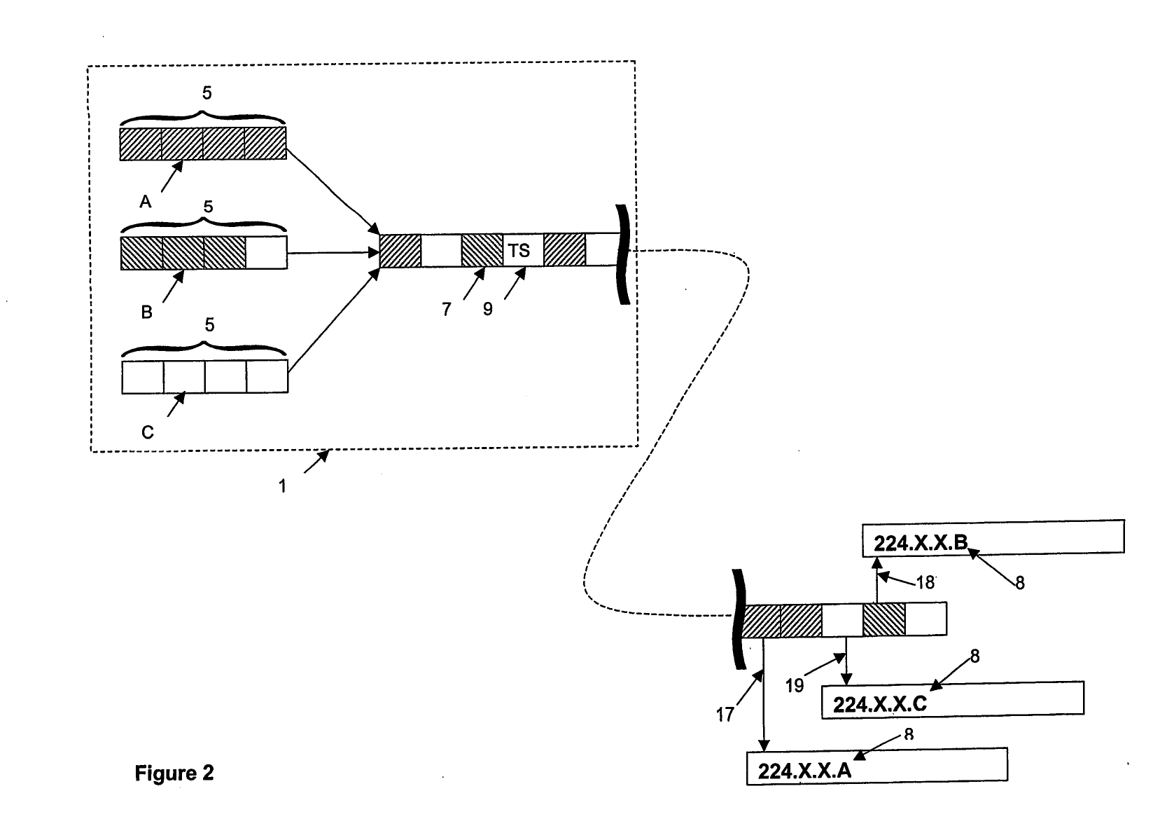

Referring to FIGS. 1 and 2, there is shown a broadband digital broadcast head-end 1 connected to a variety of sources 2, 3, 4 of content A, B, C which content or service is delivered to the head-end in the form of packets 5 of data. Each source of content A, B, C is encapsulated by a packet data processor 6 at the head end 1 and placed into a transport stream 7 where it is multiplexed with the other content similarly encapsulated at the head-end 1 by the packet data processor 6. As will be described in more detail below, multicast and possibly unicast packets include a code 8 to facilitate time division multiplex access of the content once separated from the transport stream 7. The transport stream 7 further includes packets 9 providing time stamp information and control data identifying content in the stream 7. Other mechanisms for placing content into the transport stream 7 include, data streaming, and the use of data and object carousel. Such mechanisms are well known to those skilled in the art, further details of which are available from the Digital Video Broadcast (DVB) Project which describes one particular broadband digital broadcast solution using MPEG-2 to which the invention is applicable.

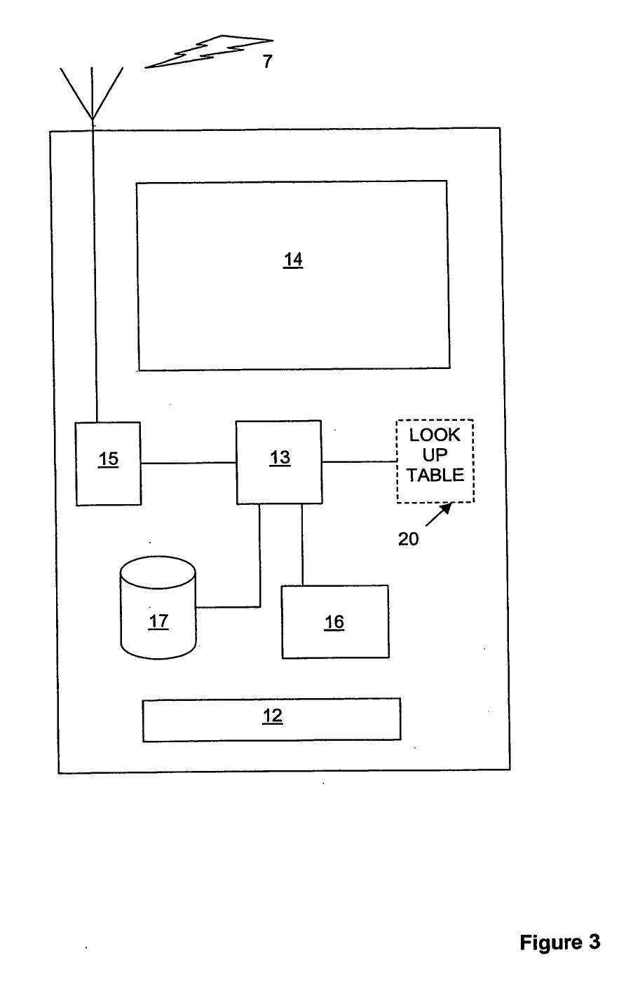

The content can include the delivery of Internet services through IP tunnelling via the broadcast channel, namely the above mentioned transport stream. Such services may be unicast, in the sense that they are a one to one provision of content or multicast in the sense that they are a one to many provision of content. In IP terms, a multicast address is differentiated from a unicast address by inspecting the most significant byte. A particular block of IP addresses are dedicated to use by multicast services namely 224.0.0.0 to 239.255.254.0 using the well-known dotted decimal notation known from IPv4. Thus, where a service is intended to be multicast, the service must ensure that an address from this block is utilised in the destination address portion of each IP packet. As has been mentioned above, certain packets are intended to be delivered to a terminal 10, which may be a mobile terminal shown in more detail in FIG. 3, at particular time slots during a service period of that terminal 10. The information necessary to ensure delivery of a packet at the correct slot in the service period is delivered with the packet itself in the form of the coding 8 of the packet destination address. In one embodiment, the coding 8 is provided by the provider of the service 2,3,4. In another embodiment, the coding 8 is added by the packet data processor 6 after receipt of the respective IP stream from a service provider 2,3,4.

It will be clear to those skilled in the art that provided the coding 8 is chosen with care to avoid conflict with existing standards and protocols, there are a number of alternatives to introducing the code into the IP address. In order to illustrate some at least of the alternatives, we shall assume that the three above mentioned services A, B, C are being delivered in the transport stream, either of which may be of interest to a user of terminal capable of receiving the broadcast and described in greater detail below.

Thus, the first service A is a continuous service. The second service B is periodic with delivery of the service taking place for 1 second every 30 seconds. The third service C is available for 10 seconds commencing at 12:12:34 UTC.

In one coding format a mark and space approach is utilised in which bits are set high to indicate transmission during a particular slot and set low to indicate no transmission during that slot. That is, the packet data processor 6 or the service provider 2,3,4 allocates a final portion of the IP address space, or indeed any other non-reserved but predetermined portion of the IP address space to mask the periodicity. Thus, where as in the terminal 10 described below, the service period comprises 256 separate slots, service A is X.X.X.A where A=255, that is all 256 time slots are used for transmission. In the case of service B limitations on the size of the address space available under IPv4 of 32 bits and IPv6 of 128 bits prevent the packet data processor from allocating a bit to every time slot where the time slots number 256 in total. Thus, instead of flagging every period with a bit, in one variant, the time slots of 234 milliseconds inside the service period of 60 seconds are periodic, so that 16 bits instead of 256 bits could be used. 8 bits (byte M) represent the number of 1's and 8 bits (byte N) represent the number of 0's. e.g. M=50, N=206 means “50x1's+206x0's”, e.g. M=10, N=54 means “10x1's+54x0's+10x1's+54x0's+10x1's+54x0's+10x1's+54x0's”. In an alternative, 8 time slots instead of 256 could be used which would fit into IPv4. Those skilled in the art will recognise that a similar approach may be taken when coding the service C.

It will further be recognised that a time offset may be introduced into the coding to allow a service to commence at a time slot other than that at the beginning of a service period. Thus, in the case of service B a zero offset represents “5×1's+123x0's+5×1's+123x0's” but 127 other possibilities exist, such as “100x0's+5×1's+123x0's+5×1's+23x0's”. However providing an offset through an 8 bit space (byte K), gives as an example K=64, M=24, N=40 meaning “64x0's+24×1's+104x0's+24×1's+40x0's”.

In another coding format, rather than explicitly define the time slots at which the service is available in the mask, once again, the packet data processor 6 or the service provider 2,3,4 allocates a final portion of the IP address space, or indeed any other non-reserved but predetermined portion of the IP address space to mask the periodicity. In this format, an algorithm is used to generate a code which represents a particular periodicity. By suitable choice of algorithm, time slots corresponding to services A, B and C can be represented in a format for inclusion in the address space which requires less bits than the direct mark space mapping described above. As such, this format is particularly suitable for the smaller address space available under IPv4 although it is also suitable, of course, for the larger address space available under IPv6.

In a still further coding format, the time slots during which a service is available are once again encoded in the form of a portion of the non-reserved but predetermined portion of the address space to mask the periodicity. However, the coding is derived from a look-up table 11 which uniquely identifies a particular time slot sequence.

The transport stream 7 is broadcast to a set of terminals which in the case of a satellite system fall under the satellite footprint. In the case of a terrestrial system, the receiving terminals fall within areas of transmission coverage of a network. Each terminal, which includes a mobile terminal 10, is typically under the control of a user at least as far as she is able to select particular content from that currently being transmitted in the transport stream 7. Taking the mobile terminal 10 as an example, the mobile terminal 10 includes an internal power supply 12, such as a rechargeable battery supplying power to a controller 13, user interface 14 and a receiver 15. The terminal 10 also incorporates both memory 16 and storage 17 necessary to execute applications and consume content. A fixed terminal may, of course, dispense with the requirement for a internal source of power.

The receiver 15, as has been mentioned, has a proportionally larger power consumption than the other components of the terminal 10. In order to minimise drain on the internal power supply 12, the receiver 15 may be switched on and off in response to instructions received from the controller 13. The receiver 15, when in operation, receives the transport stream 7 over the air, in the case of satellite or terrestrial transmission. The operation of the receiver 15 is such that over a predetermined and possibly variable service period, say 60 seconds; the receiver 15 is capable of being switched into operation for one or more of each of a set of periods of fixed time duration determined by the accuracy of a receiver clock forming part of the controller 13. For example, where the receiver clock accuracy can be maintained at 234 milliseconds, each period may last for 234.375 milliseconds there being 256 such periods within the aforementioned 60 second service period.

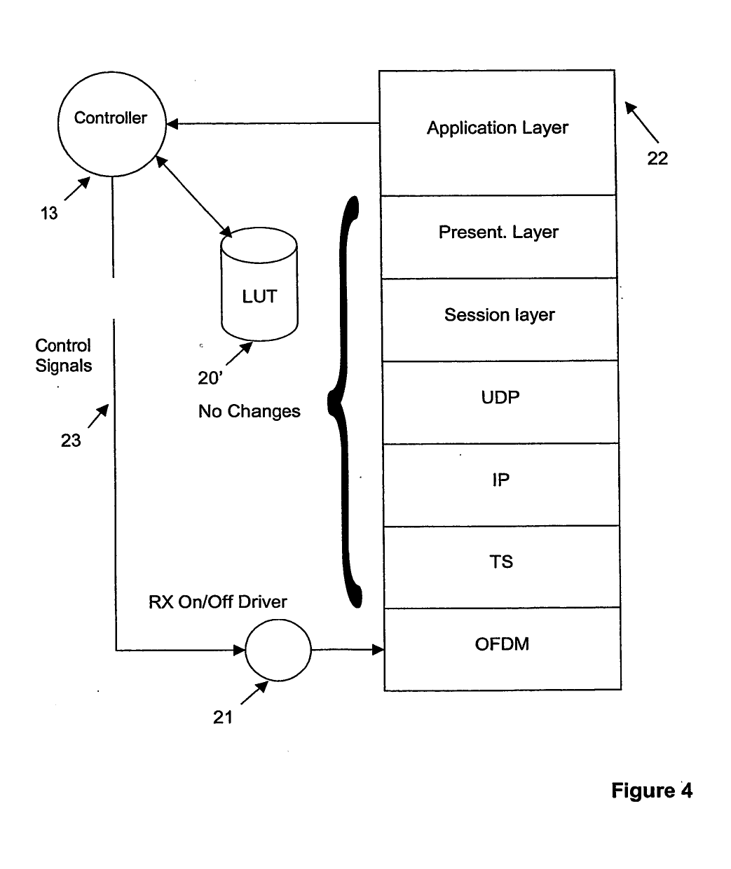

The controller 13, is operable to switch the receiver 15 between on and off states in order to provide 256 time slots each of 234.375 millisecond duration over a 60 second service period. In use, the switching of the receiver 15 is carried out in response to an analysis by the controller 13 of the IP address of a multicast or indeed unicast content available in the transport stream. Accordingly, the controller listens at a predetermined IP address for announcements of current and forthcoming services, in this case we have the examples of service A, B and C. The announcements themselves may be made using the mechanism for facilitating the delivery of content in a multicast environment provided by the Session Announcement Protocol (SAP), details of which are set out in RFC2974 published by the Internet Engineering Task Force (IETF repository at http://www.ietf.org) and the Session Description Protocol (SDP), details of which are to be found in RFC2327 published by the Internet Engineering Task Force (IETF repository at http://www.ietf.org). At this predetermined address, the controller 13 is able to obtain from the transport stream 7, information identifying a particular socket 17,18,19 at which a service is available, together with details of the time slots at which the service can be received in the form of an encoded portion of the IP address as indicated previously. The information is used by an application, at an application layer 22 shown in more detail in FIG. 4 to build a list of available content from which a user via the user interface 14, which may be a browser, is able to select. Once the user has made a selection the controller 13 extracts from the portion of the IP address, the coding 8 representing the slots at which the service is delivered. Irrespective of the coding format used to set out the delivery time slots of the selected service, the controller 13 will seek the coding 8 at the predetermined position in the IP address space. Once provided with the coding the steps taken to extract the delivery time slots from the coding 8 will vary depending on the particular coding format. Irrespective of the particular coding format used, the resulting delivery slot information is then used by the controller 13 to configure the receiver 15 to receive the service. Thus the receiver 15 is switched on to receive the service at the appropriate time slots and switched off when no service is being delivered by a driver 21 in, thereby reducing the power consumption of the receiver 15 and thus the terminal 10 as a whole during off time slots.

Returning to the three examples of coding format, in each case, the controller 13 parses the IP address to obtain the portion 8 encoding the delivery time slot information. In the first example, the controller 13 then obtains the sequence of delivery time slots directly from the encoding and uses these to control the switching of the receiver 15 between on and off states. In the second example, the controller 13 includes an algorithm necessary to determine from the coding the delivery time slots. Clearly, the algorithm may be deployed in software as an application or may be a hardware solution. Furthermore, the particular algorithm may be changed at the head-end 1 provided the change and the corresponding algorithm is propagated to the terminal 10. In the third example, the controller 13 is provided with access to a look-up table 20 matching that held by the packet data processor 6. Thus, the controller 13 firstly obtains the coding from the IP address and then consults the look-up table 20 to determine the particular delivery time slots. Clearly, any changes in the look-up table 11 at the head-end may be propagated over the air to the terminal look-up table 20.

1. A method of defining Time Division Multiplex access slots in an IP address, the method comprising encoding a schedule of delivery time slots as a mask in said IP address.

2. A method as claimed in claim 1, wherein said schedule is encoded using a bit flagged format.

3. A method as claimed in claim 1, wherein said schedule is encoded using an algorithm based format.

4. A method as claimed in claim 1, wherein said schedule is encoded using a look-up table format.

5. A method of deriving Time Division Multiplex access slots from an IP address, the method comprising identifying a portion of said address encoded with a schedule of delivery time slots and decoding said schedule.

6. A method as claimed in claim 5, wherein said schedule is decoded using a bit flagged format.

7. A method as claimed in claim 5, wherein said schedule is decoded using an algorithm based format.

8. A method as claimed in claim 5, wherein said schedule is decoded using a look-up table format.

9. A method of generating Time Division Multiplex access slots for a service in an IP transport stream, the method comprising receiving an IP address identifying a service for inclusion in said stream, obtaining a schedule of delivery time slots for said service and encoding said schedule as a mask on said IP address.

10. A method as claimed in claim 9, wherein said schedule is encoded using bit flagged format.

11. A method as claimed in claim 9, wherein said schedule is encoded using an algorithm based format.

12. A method as claimed in claim 9, wherein said schedule is encoded using a look-up table format.

13. A method as claimed in claim 9, wherein a basic time increment for said slots is communicated via said IP transport stream.

14. A method of obtaining Time Division Multiplex access slots of a service in an IP transport stream, the method comprising identifying an IP address of a service in said transport stream and decoding a schedule of delivery time slots for said service previously encoded as a mask on said IP address.

15. A method as claimed in claim 14, wherein said schedule is decoded using bit flagged format.

16. A method as claimed in claim 14, wherein said schedule is decoded using an algorithm based format.

17. A method as claimed in claim 14, wherein said schedule is decoded using a look-up table format.

18. A method as claimed in claim 14, wherein a basic time increment for said slots is obtained from said IP transport stream.

19. A service reception method for a terminal including a selectably operable receiver, the method comprising receiving an IP transport stream including an announcement of services in said stream, selecting a service from said stream, deriving from an IP address of said service scheduled delivery time slots for said service encoded in said IP address and selectably operating said receiver in accordance with said schedule to receive said service at said IP address.

20. A method as claimed in claim 19, wherein said receiver is operable in accordance with a basic time increment for said slots derived from said transport stream.

21. An apparatus for obtaining Time Division Multiplex access slots of a service in an IP transport stream, the apparatus comprising:
a memory device for storing a program; and
a controller in communication with the memory device, the controller operative with the program to:
identify an IP address of a service in said transport stream; and
decode a schedule of delivery time slots for said service previously encoded as a mask on said IP address.

22. An apparatus for defining Time Division Multiplex access slots in an IP address, the apparatus comprising:
a memory device for storing a program; and
a controller in communication with the memory device the controller operative with the program to:
encode a schedule of delivery time slots as a mask in said IP address.
